(19) United States
(12) Patent Application Publication
(10) Pub. No.: US 2019/0280307 A1
(43) Pub. Date: Sep. 12, 2019

(54) COMPOSITE ELECTRODE LAYER FOR POLYMER ELECTROLYTE FUEL CELL

(71) Applicant: GM GLOBAL TECHNOLOGY OPERATIONS LLC, Detroit, MI (US)

(72) Inventors: Nagappan Ramaswamy, Rochester Hills, MI (US); Timothy Fuller, Pittsford, NY (US); Swaminatha Kumaraguru, Rochester Hills, MI (US)

(21) Appl. No.: 15/915,846

(22) Filed: Mar. 8, 2018

(51) Int. Cl. H01M 4/86; H01M 8/1018; H01M 8/0258; H01M 8/1004; H01M 4/88; H01M 4/92

(52) U.S. Cl. CPC H01M 4/8673; H01M 8/1018; H01M 4/8668; H01M 4/8605; H01M 2008/1095; H01M 8/1004; H01M 4/8875; H01M 4/926; H01M 8/0258

(57) ABSTRACT

A polymer electrolyte membrane fuel cell includes a proton-conductive polymer electrolyte membrane, an anode catalyst layer overlying a first face of the polymer electrolyte membrane, and a cathode catalyst layer overlying a second face of the polymer electrolyte membrane. At least one of the anode catalyst layer or the cathode catalyst layer includes a composite electrode layer that comprises a colloidal or soluble ionomer binder component, a catalyst dispersed along with the colloidal or soluble ionomer binder component, and insoluble ionomer nanofibers disseminated throughout a thickness of the composite electrode layer. The presence of the insoluble ionomer nanofibers within the composite electrode layer may enhance the voltage performance of the fuel cell, particularly at high current densities and/or low relative humidity operating conditions. A method of making a composite electrode layer for a polymer electrolyte membrane fuel cell is also disclosed.

### INTRODUCTION

A polymer electrolyte membrane (PEM) fuel cell is an electrochemical device that converts the chemical energy of fuel and oxidant gasses into direct-current electricity and heat. The fuel gas may be hydrogen (H₂) and the oxidant gas may be air or oxygen (O₂). A PEM fuel cell includes a membrane-electrode assembly (MEA) and a pair of gas-diffusion media layers. The MEA includes a proton-conductive solid polymer electrolyte that supports an anode catalyst layer on one side and a cathode catalyst layer on the other side. A gas diffusion media layer is disposed on each side of the MEA, and an electrically-conductive plate in the form of a bipolar plate or an end plate is disposed outside each of the gas diffusion media layers. During operation of a PEM fuel cell, hydrogen gas is delivered to the anode catalyst layer of the MEA and air or oxygen is delivered to the cathode catalyst layer. The hydrogen gas is dissociated at the anode catalyst layer to generate protons and electrons. The protons migrate to the cathode catalyst layer through the proton-conductive solid polymer electrolyte and the electrons are directed to the cathode catalyst layer through an external electrical circuit to perform work. The protons and electrode eventually reach the cathode catalyst layer where they react with oxygen to generate water. In many instances, including for vehicle propulsion applications, a multitude of PEM fuel cells are arranged into a fuel cell stack to obtain increased voltage and power outputs.

Each of the anode and cathode catalyst layers of a PEM fuel cell MEA has conventionally included a colloidal or soluble ionomer distributed around finely-divided catalyst, such as platinum, loaded onto a high-surface area carbon support. The function of the ionomer, which is ideally envisioned to be homogenously dispersed, is to enable proton conduction within the catalyst layer structure. This construction of the anode and cathode catalyst layers generally performs satisfactorily at low current density and/or wet relative humidity operating conditions of the fuel cell. However, at high cell current densities and/or dry relative humidity conditions, which occur during periods of high current demand from the fuel cell, a PEM fuel cell that includes standard anode and cathode catalyst layers tends to suffer a finite loss in cell voltage. The cause of this finite voltage loss is believed to be related to the structure and constituent materials in the MEA catalyst layers and, in particular, the cathode catalyst layer. One specific cause of the finite loss in cell voltage is believed to be an increase in the proton transport resistance of the cathode catalyst layer. More specifically, an inhomogeneity in the ionomer network of the cathode catalyst layer, which is derived from the colloidal or soluble form of the ionomer, is thought to contribute to a loss in proton transport pathways throughout and across the thickness of the cathode catalyst layer. The anode catalyst layer may face similar challenges, albeit to a lesser extent than the cathode catalyst layer.

### SUMMARY OF THE DISCLOSURE

A polymer electrolyte membrane fuel cell according to an embodiment of the present disclosure includes a proton-conductive solid polymer electrolyte membrane, an anode catalyst layer, and a cathode catalyst layer. The polymer electrolyte membrane has a first face and an opposed second face. The anode catalyst layer overlies the first face of the polymer electrolyte and the cathode catalyst layer overlies the second face of the polymer electrolyte. Additionally, at least one of the anode catalyst layer or the cathode catalyst layer includes a composite electrode layer that comprises a colloidal or soluble ionomer binder component, a catalyst, and insoluble ionomer nanofibers disseminated throughout a thickness of the composite electrode layer such that at least some of the ionomer nanofibers contact the polymer electrolyte membrane. The ionomer nanofibers are present within the composite electrode layer at a weight percent ranging from 5 to 20 based on a total weight of the composite electrode layer.

The polymer electrolyte membrane fuel cell may include additional features or be further defined. For example, the ionomer nanofibers may have an aspect ratio of greater than 20. As another example, at least some of the ionomer nanofibers may be composed of a sulfonated fluoropolymer. Still further, at least some of the ionomer nanofibers may be composed of a copolymer having a polytetrafluoroethylene backbone and perfluoroether pendant side chains that terminate in sulfonic acid groups. And, in one particular embodiment, the cathode catalyst layer of the polymer electrolyte membrane fuel cell comprises the composite electrode layer. In yet another embodiment, the colloidal or soluble ionomer binder component of the composite electrode layer may comprise a sulfonated fluoropolymer. Additionally, the catalyst of the composite electrode layer may comprise platinum group metal nanoparticles supported on carbon support particles. As yet another example, at least some of the ionomer nanofibers extend from a first major face of the composite electrode layer to a second major face of the composite electrode layer and thereby fully traverse the thickness of the composite electrode layer.

The polymer electrolyte membrane fuel cell may further include additional structural features. For instance, the fuel cell may also include a first gas diffusion media layer overlying the anode catalyst layer, a second gas diffusion media layer overlying the cathode catalyst layer, a first electrically-conductive flow field plate overlying the first gas diffusion media layer and being configured to deliver hydrogen gas to the anode catalyst layer, and a second electrically-conductive flow field plate overlying the second gas diffusion media layer and being configured to deliver an oxidant gas to the cathode catalyst layer.

A polymer electrolyte membrane fuel cell according to another embodiment of the present disclosure includes a proton-conductive solid polymer electrolyte membrane, and anode catalyst layer, and a cathode catalyst layer. The polymer electrolyte membrane has a first face and an opposed second face. The anode layer overlies the first face of the polymer electrolyte and the cathode layer overlies the second face of the polymer electrolyte. Moreover, the cathode catalyst layer is a composite electrode layer that comprises a colloidal or soluble ionomer binder component, a catalyst dispersed along with the soluble ionomer binder component, and ionomer nanofibers disseminated throughout a thickness of the composite electrode layer so as to establish a random network of proton transport pathways across the thickness of the composite electrode layer from a first major face to a second major face of the composite electrode layer. The polymer electrolyte membrane fuel cell may further include a first gas diffusion media layer overlying the anode catalyst layer, a second gas diffusion media layer overlying the cathode catalyst layer, a first electrically-conductive flow field plate overlying the first gas diffusion media layer and being configured to deliver hydrogen gas to the anode catalyst layer, a second electrically-conductive flow field plate overlying the second gas diffusion media layer and being configured to deliver an oxidant gas to the cathode catalyst layer.

The polymer electrolyte membrane fuel cell may include additional features or be further defined. For example, the ionomer nanofibers may have an aspect ratio of greater than 20. As another example, the ionomer nanofibers may be present within the composite electrode layer at a weight percent ranging from 5 wt % to 20 wt % based on a total weight of the composite electrode layer. In yet another example, the colloidal or soluble ionomer binder component of the composite electrode layer may comprise a sulfonated fluoropolymer, and the catalyst may comprise platinum group metal nanoparticles supported on carbon support particles. And, in still another example, at least some of the ionomer nanofibers may be composed of a sulfonated fluoropolymer.

A method of making a composite electrode layer for a polymer electrolyte membrane fuel call may include several steps. In one step, an ionomer solution is prepared that includes ionomer particles dissolved or dispersed in a solvent. In another step, insoluble ionomer nanofibers are introduced into the ionomer solution. In still another step, a catalyst is introduced into the ionomer solution to form an electrode ink slurry. In yet another step, the electrode ink slurry is cast onto a surface of a substrate to apply a wet precursor composite layer to the substrate. In another step, the solvent is removed from the wet precursor composite layer to derive a composite electrode layer on the surface of the substrate. The composite electrode layer has a first major face and an opposed second major face and includes an interpenetrating porous matrix that includes the catalyst, a colloidal or soluble ionomer binder component distributed in and around the catalyst, and the insoluble ionomer nanofibers disseminated throughout a thickness of the composite electrode layer such that at least some of the ionomer nanofibers are exposed at the first major face, the second major face, or both of the first and second major faces.

The method of making the composite electrode layer may include additional steps or be further defined. For instance, the substrate upon which the electrode ink slurry is cast may be a proton-conductive solid polymer electrolyte membrane or a gas diffusion media layer. In another example, the substrate may be a decal substrate. When the substrate is a decal substrate, the method may include the additional step of transferring the composite electrode layer from the decal substrate to a face of a proton-conductive solid polymer electrolyte membrane. Still further, in another example, the colloidal or soluble ionomer binder component of the composite electrode layer may comprise a sulfonated fluoropolymer and the catalyst may comprise platinum group metal nanoparticles supported on carbon support particles. And, in yet another example, at least some of the ionomer nanofibers may extend from the first major face of the composite electrode layer to the second major face of the composite electrode layer and thereby fully traverse the thickness of the composite electrode layer.

### BRIEF DESCRIPTION OF THE DRAWINGS

FIG. 1 is a schematic cross-sectional view of a composite electrode layer according to practices of the present disclosure;

FIG. 2 is a magnified view of the encircled portion of the composite electrode layer depicted in FIG. 1;

FIG. 3 is a schematic cross-sectional view of one embodiment of a polymer electrolyte membrane fuel cell that includes the composite electrode layer shown in FIG. 1 as part of the membrane-electrode-assembly of the fuel cell (specifically as the cathode catalyst layer);

FIG. 4 is a plot of three polarization curves in which voltage (in Volts (V)) is represented on the y-axis and current density (in ampere per centimeter squared (A/cm²)) is represented on the x-axis, and wherein the two of the three polarization curves are derived from PEM test fuel cells included a composite electrode layer according to practices of the present disclosure as the cathode catalyst layer and the other PEM test fuel cell included a conventional cathode catalyst layer;

FIG. 5 is a graph of protonic resistance, or proton transport resistance, in which the resistance (in ohms centimeter squared (Ωcm²)) is represented on the y-axis for three different cathode catalyst layers that include varying amounts of ionomer nanofibers; and;

FIG. 6 is a graph of mass activity in which the kinetic activity of the catalyst (in milliamperes per milligram of catalyst particles (mA/mg)) is represented on the y-axis for five different cathode catalyst layers that include varying amounts of ionomer nanofibers;

### DETAILED DESCRIPTION

A composite electrode layer for use within a membrane electrode assembly of a polymer electrolyte membrane (PEM) fuel cell is disclosed. The composite electrode layer is an interpenetrating porous matrix that includes a catalyst comprised of agglomerates of supported catalyst particles, a colloidal or soluble ionomer binder component distributed in and around the catalyst agglomerates, and insoluble ionomer nanofibers. The ionomer nanofibers collectively traverse the thickness of the porous matrix and thus extend from one major face of the composite electrode layer to the other opposed major face. The composite electrode layer may be employed as the anode catalyst layer, the cathode catalyst layer, or both, within the MEA. When employed as the cathode catalyst layer, the ionomer nanofibers of the composite electrode layer reduce proton transport resistance of the electrode layer compared to conventional electrode layers that do not include such nanofibers. The reduction in proton transport resistance, in turn, enhances PEM fuel cell voltage performance, especially at high current densities and/or low relative humidity operating conditions. The ionomer nanofibers may also improve catalyst mass activity and minimize the effects of ionomer permeation into the microporous layer of an adjacent gas diffusion layer since the nanofibers are insoluble in water.

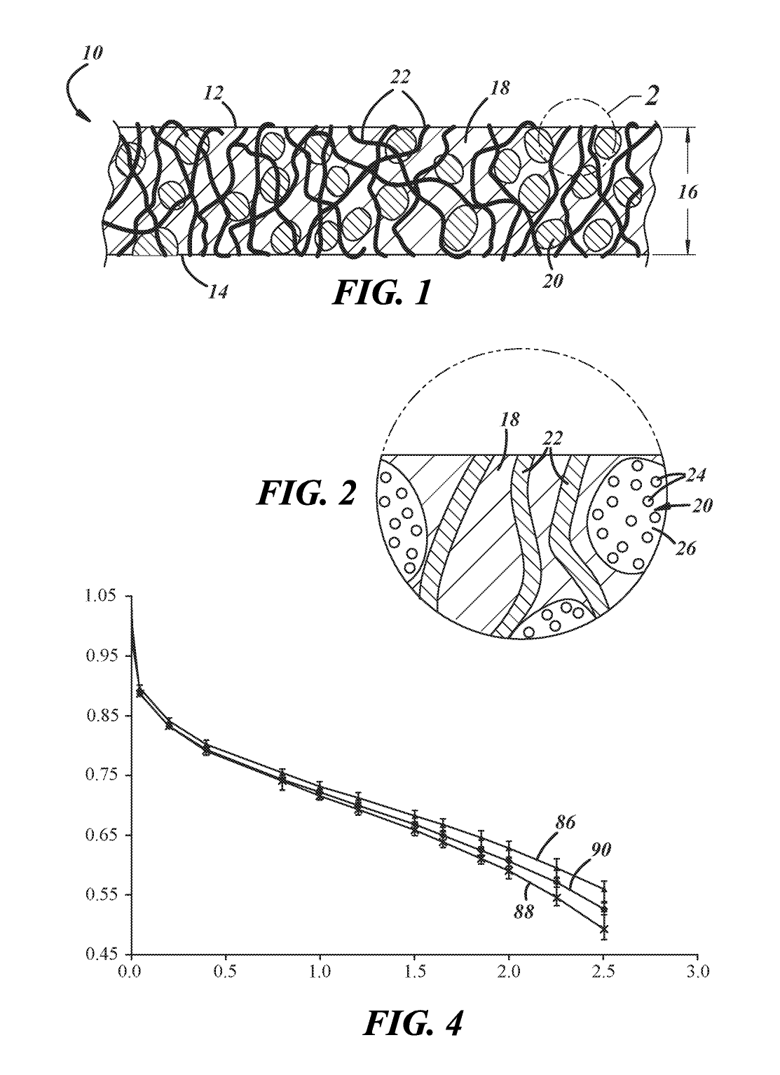

Referring now to FIGS. 1-2, a composite electrode layer 10 is shown. The composite electrode layer 10 is an interpenetrating porous matrix that includes a first major face 12 and an opposed second major face 14 that define a thickness 16 of the electrode layer 10. The composite electrode layer 10 includes a colloidal or soluble ionomer binder component 18, a catalyst 20, and ionomer nanofibers 22. In many applications, the thickness 16 of the composite electrode layer 10 lies between 5 μm and 20 μm or, more narrowly, between 6 μm and 12 μm. As will be further described below, the composite electrode layer 10 is preferably employed as the cathode catalyst layer of a MEA of a PEM fuel cell, although it may also be employed as the anode catalyst layer of the MEA as well. The composite electrode layer 10 is particularly useful as a cathode catalyst layer because of its capacity to reduce proton transport resistance, which is noteworthy since proton resistance in the cathode catalyst layer can cause the high current density performance of a PEM fuel cell to suffer a finite loss in cell voltage.

The colloidal or soluble ionomer binder component 18 functions to support and bind the catalyst 20 and the nanofibers 22 together while also providing proton conductivity. The colloidal or soluble ionomer binder component 18 is composed of a proton-conductive polymer. Sulfonated fluoropolymers are one particular group of proton-conductive polymers that may constitute the colloidal or soluble ionomer binder component 18. For example, the sulfonated fluoropolymer may be a copolymer that has a polytetrafluoroethylene (PTFE) backbone with perfluoroether pendant side chains that terminate in sulfonic acid groups. Some examples of such sulfonated fluoropolymers include Nafion® and Aquivion®, which are represented below by formulas (1) and (2), respectively:

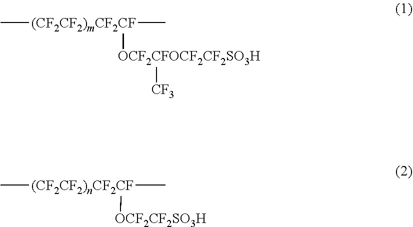

Other proton-conductive polymers besides sulfonated fluoropolymers may also constitute the colloidal or soluble ionomer binder component 18, including those that have a PTFE backbone with perfluoroether pendant side chains that terminate in carboxylic acid groups instead of sulfonic acid groups.

The catalyst 20 is dispersed throughout the porous matrix of the composite electrode layer 10 operates to accelerate the half-reaction in the composite electrode layer 10 and facilitate DC current generation by the PEM fuel cell. The two half reactions that occur within the PEM fuel cell are the oxidation reaction at the anode catalyst layer and the reduction reaction at the cathode catalyst layer. These two half-reactions as well as the net reaction that occur within a PEM fuel cell are depicted below:

2H₂→4H⁺+4e⁻(oxidation half-reaction at the anode catalyst layer)

O₂+4H⁺+4e⁻→2H₂O (reduction half-reaction at the cathode catalyst layer)

2H₂+O₂→2H₂O (net reaction)

The catalyst 20 used for either the hydrogen oxidation half-reaction or the oxygen reduction half-reaction may include finely divided catalyst particles 24 and electrically-conductive support structures 26 that support the catalyst particles 24, as shown best in FIG. 2. In a preferred embodiment, for example, the catalyst particles 24 may be finely divided platinum group metal nanoparticles—such as platinum or a platinum/ruthenium alloy or a platinum/cobalt alloy—and the support structures 26 may be agglomerates of carbon support particles. The platinum group metal nanoparticles may be supported on carbon black, acetylene black, or other particles (e.g., carbon nanotubes, carbon nanocages, etc.) and, typically, have particle diameters that range from 2 nm to 5 nm. In one specific example, the catalyst 20 may comprise platinum nanoparticles supported on high surface area carbon black material such as Vulcan black XC-72R or Ketjen black EC-300J.

The ionomer nanofibers 22 are disseminated throughout the porous matrix of the composite electrode layer 10 and provide additional proton transport pathways within the composite electrode layer 10. These additional proton transport pathways are advantageous because the colloidal or soluble ionomer binder component 18 may not traverse the entire thickness 16 of the electrode layer and may not be well-connected. Indeed, the ionomer nanofibers 22 establish a random network of proton transport pathways across the thickness 16 of the composite electrode layer 10 between the first and second major faces 12, 14 of the electrode layer 10. In other words, ionomer nanofibers 22 are present throughout the thickness 16 of the composite electrode layer 10 and are exposed at each of the first and second major faces 12, 14 of the electrode layer 10, although the same ionomer nanofibers 22 need not necessarily be exposed on both major surfaces 12, 14. The ionomer nanofibers 22 may have a diameter that ranges from 10 nm to 2000 nm or, more narrowly, from 50 nm to 300 nm, and may be continuous or severed to a particular length. When severed, for instance, the ionomer nanofibers 22 may have a length that ranges from 1 μm to 100 μm or, more narrowly, from 5 μm to 15 μm. Moreover, at least some of the ionomer nanofibers 22, and preferably all of the nanofibers 22, have a length that allows the nanofibers 22 to extend all the way between the first and second major faces 12, 14 of the electrode layer 10, meaning that the same nanofibers 22 are exposed at each of the first and second major faces 12, 14. To help promote traversal of the thickness 16 of the electrode layer 10, the ionomer nanofibers 22 may be high aspect ratio nanofibers characterized by an aspect ratio (length/diameter) of greater than 20.

The ionomer nanofibers 22 included in the composite electrode layer 10 are composed of a proton-conductive polymer in much the same way as the colloidal or soluble ionomer binder component 18. The ionomer nanofibers 22 may be formed of a sulfonated fluoropolymer, as described above, or a fluoropolymer that includes pendant side chains terminating in carboxylic acid groups instead of sulfonic acid groups, as is also described above. Examples of such proton-conductive polymers include Nafion® and Aquivion®. All of the ionomer nanofibers 22 may be formed of the same proton-conductive polymer, if desired, or they may be formed of a combination of different proton-conductive polymers. The proton-conductive polymer that constitutes the colloidal or soluble ionomer binder component 18 and the proton-conductive polymer(s) that constitute the ionomer nanofibers 22 may also be the same or different. While the colloidal or soluble ionomer binder component 18 and the ionomer nanofibers 22 are both constructed from a proton-conductive polymer, the two ionomer structures 18, 22 may differ in some respects. Most notably, the ionomer nanofibers 22 are not soluble in water due to the fact that they are fabricated by a fiber-forming process, such as melt extrusion. The colloidal or soluble ionomer binder component 18, on the other hand, is dispersible or soluble in water.

The presence of the ionomer nanofibers 22 in the composite electrode layer 10 and their establishment of a random network of proton transport pathways can reduce the proton transport resistance within the electrode layer 10. Such a reduction in proton transport resistance can be achieved without overly restricting the porosity of electrode layer 10 such that gas flow, and particularly oxygen flow, is impeded to the point of causing a noticeable performance decline in the PEM fuel cell. In addition to their effect on proton transport resistance, the ionomer nanofibers 22 also introduce insoluble ionomer material into the composite electrode layer 10. The insolubility of the ionomer nanofibers 22 may improve the mass activity of the catalyst 20 since the nanofibers 22 generally cannot be dissolved by water and, therefore, have a tendency to minimize sulfonate poisoning by hindering direct contact between the catalyst particles 24 and the sulfonate groups of the colloidal or soluble ionomer binder component 18. The insolubility of the ionomer nanofibers 22 can also minimize ionomer loss from the composite catalyst layer 10, which can help avoid ionomer permeation into the microporous layer of the adjacent gas diffusion media layer when the composite electrode layer 10 is incorporated into a PEM fuel cell.

The content of each of the colloidal or soluble ionomer binder component 18, the catalyst 20, and the ionomer nanofibers 22 may be adapted to best maintain PEM fuel cell voltage over the current density operating window of the cell. As the amount of ionomer nanofibers 22 in the composite electrode layer 10 is increased, the proton transport resistance is decreased within the electrode layer 10, which helps curtail ohmic loss in the cell. However, incorporating too much ionomer nanofibers 22 in the composite electrode layer 10 can hinder gas flow through the electrode layer 10, which may contribute to mass transport voltage loss at high current densities of the cell. A balance between the competing proton conductivity gains and the mass transfer voltage losses attributable to the ionomer nanofibers 22 can nonetheless be attained that results in a gain in cell voltage performance. This is especially true when the cell is operated at high current densities of 1.0 A/cm² or greater. In many instances, for example, the composite electrode layer 10 includes 30 wt % to 50 wt % of the colloidal or soluble ionomer binder component 18, 50 wt % to 70 wt % of the catalyst 20 (catalyst particles 24 plus electrically-conductive support structures 26) with a catalyst loading of 0.05 mgPt/cm² to 0.2 mgPt/cm², and 5 wt % to 20 wt % of the ionomer nanofibers 22, all based on the total weight of the electrode layer 10.

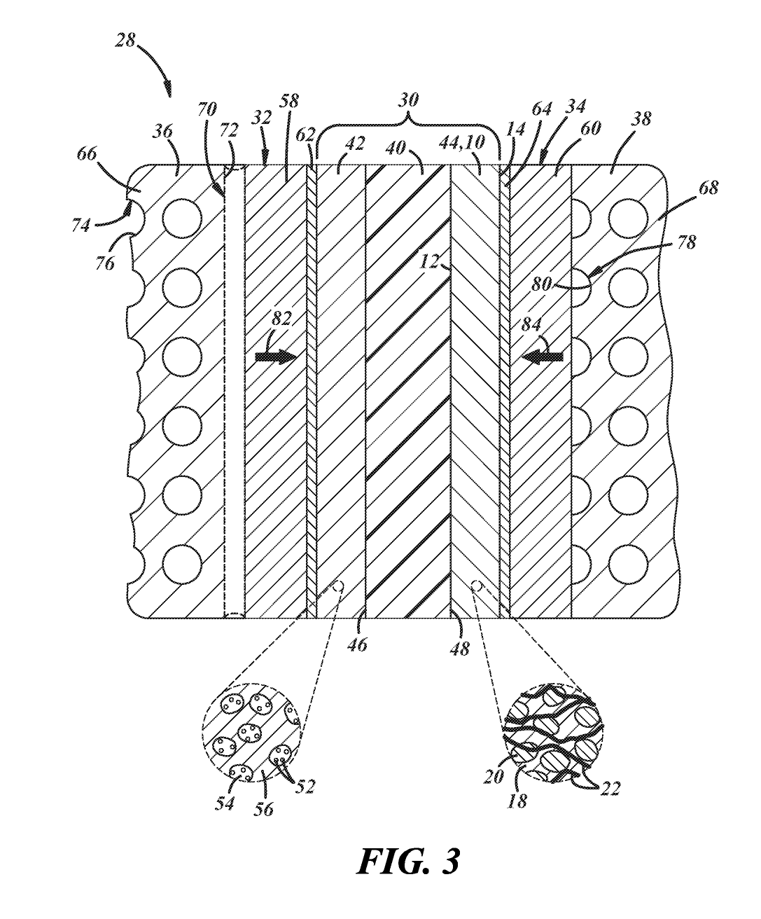

Referring now to FIG. 3, a PEM fuel cell 28 is depicted that includes the composite electrode layer 10. The PEM fuel cell 28 includes a membrane-electrode-assembly (MEA) 30 sandwiched between first and second gas diffusion media layers 32, 34 and first and second electrically-conductive flow field plates 36, 38. The MEA 30 includes a proton-conductive solid polymer electrolyte membrane 40, an anode catalyst layer 42, and a cathode catalyst layer 44. The proton-conductive solid polymer electrolyte membrane 40 includes a first face 46 and an opposed second face 48, and is composed of an ionomer such as, for example, a sulfonated fluoropolymer as described above in connection with the colloidal or soluble ionomer binder component 18 or any other proton-conductive polymer. The proton-conductive solid polymer electrolyte membrane 40 is an electrical insulator that allows protons to migrate through its thickness but does not conduct electricity. The anode catalyst layer 42 overlies the first face 46 of the proton-conductive solid polymer electrolyte membrane 40 and the cathode catalyst layer 44 overlies the second face 48. The primary functions of the anode catalyst layer 42 and the cathode catalyst layer 44 are to accelerate the hydrogen oxidation half-reaction and the oxygen reduction half-reaction, respectively.

At least one of the anode catalyst layer 42 or the cathode catalyst layer 44 may be constructed as the composite electrode layer 10 described above in connection with FIGS. 1-2. As shown here, for example, at least the cathode catalyst layer 44 may be constructed as the composite electrode layer. To that end, the first major face 12 of the composite electrode layer 10 overlies and makes contact with the second face 48 of the proton-conductive solid polymer electrolyte membrane 40. This interfacial contact results in the ionomer nanofibers 22 exposed at the first major face 12 of the composite electrode layer 10 making contact with the second face of the 48 of the proton-conductive solid polymer electrolyte membrane 40 to establish direct protonic communication between the solid polymer electrolyte 40 and the random network of proton transport pathways provided by the ionomer nanofibers 22 within the electrode layer 10. As for the anode catalyst layer 42 on the opposite first face 46 of the proton-conductive solid polymer electrolyte membrane 40, it may be constructed as a conventional electrode layer that includes catalyst particles 52 supported on electrically-conductive support particles 54 that are dispersed throughout the layer 42 along with a colloidal or soluble ionomer binder component 56, as shown. The catalyst particles 52, the electrically-conductive support particles 54, and the soluble ionomer binder component 56 may be the same as described above in connection with the composite electrode layer 10.

The first and second gas diffusion media layers 32, 34 are disposed on opposite sides of the MEA 30 inward of the first and second electrically-conductive flow field plates 36, 38. The first gas diffusion media layer 32 overlies the anode catalyst layer 42 and the second gas diffusion layer 34 overlies the cathode catalyst layer 44 (constructed as the composite electrode layer 10 in FIG. 3). Each of the first and second gas diffusion media layers 32, 34 may comprise a diffusion media 58, 60 along with an optional microporous layer 62, 64. The diffusion media 58, 60 may be carbon paper or carbon cloth, and the microporous layer 62, 64, if present, may be a layer of carbon nanoparticles dispersed within a hydrophobic binder such as polytetrafluoroethylene (PTFE). The first and second gas diffusion media layers 32, 34 operate to evenly distribute reductant gas to the anode catalyst layer 42 and oxidant gas to the cathode catalyst layer 44, help manage water within the MEA 30, conduct heat and electricity between the MEA 30 and the electrically-conductive plates 36, 38, and support the compressive forces applied to the PEM fuel cell 28.

The first and second electrically-conductive flow field plates 36, 38 are disposed adjacent to the first and second gas diffusion media layers 32, 34 opposite the MEA 30. The first electrically-conductive flow field plate 36 overlies the first gas diffusion media layer 32 and the second electrically-conductive flow field plate 38 overlies the second gas diffusion media layer 34. Each of the first and second electrically-conductive flow field plates 36, 38 may be a bipolar plate 66 or, alternatively, one of the first or second electrically-conductive flow field plates 36, 38 may be a bipolar plate 66 and the other of the first or second electrically-conductive flow field plates 36, 38 may be an end plate 68. For purposes of illustration only, the first electrically-conductive flow field plate 36 is depicted in FIG. 3 as a bipolar plate and the second electrically-conductive flow field plate 38 is depicted as an end plate 68. The bipolar plate 66, as shown, defines a first gas flow field 70 having gas flow channels 72 (for delivering hydrogen gas) on one side and a second gas flow field 74 having gas flow channels 76 (for delivering oxygen gas or air) on the other side. In contrast, the end plate 68 defines only a first gas flow field 78 with gas flow channels 80 on one side (for delivering oxygen or gas in this example). Each of the bipolar plate 66 and the end plate 68 may additionally define internal cooling channels in which water or a coolant is directed to remove heat from the PEM fuel cell 28 during operation. As for their materials of construction, the first and second electrically-conductive flow field plates are typically composed of (1) a metal base plate that is optionally covered with a conductive coating or (2) graphite.

The operation of the PEM fuel cell 28 proceeds in the normal manner with the added benefits attributed to the composite electrode layer 10. Still referring to FIG. 3, the operation of the PEM fuel cell 28 includes directing hydrogen gas 82 to the anode catalyst layer 42 through the first gas diffusion media layer 32 and, at the same time, directing air or oxygen gas 84 to the cathode catalyst layer 44 (constructed as the composite electrode layer 10 in this embodiment) through the second gas diffusion media layer 34. The hydrogen gas 82 is oxidized at the anode catalyst layer 42 to generate protons (W) and electrons. The protons migrate through the proton-conductive solid polymer electrolyte membrane 40 and the electrons are conducted back through the first gas diffusion media layer 32 to the first electrically-conductive flow field plate 36 and then directed through an external circuit (not shown) and around the electrolyte membrane 40 to perform work. The protons migrating through the proton-conductive solid polymer electrolyte membrane 40 and the electrons traveling through the external circuit eventually arrive at the cathode catalyst layer 44. Once at the cathode catalyst layer 44, the oxygen in the air or oxygen gas 84 is reduced in the presence of protons and electrons to produce water. This overall reaction is run continuously when there is a demand for electricity from the PEM fuel cell 28. And, oftentimes, as many as two hundred similar cells are arranged in a fuel cell stack to obtain the desired power output.

The PEM fuel cell 28 may be fabricated with the composite electrode layer 10 as the anode catalyst layer 42, the cathode catalyst layer 44, or both catalyst layers 42, 44, by the process described below or any other suitable process. The process described here includes obtaining an ionomer solution that includes ionomer particles dissolved (soluble ionomer) or dispersed (colloidal ionomer) in a solvent. The dissolved or dispersed ionomer particles may be composed of whatever proton-conductive polymer is desired for the porous ionomer matrix 18, and the solvent is typically water or a mixture of a water and alcohol such as, for example, 30 wt % to 40 wt % water and 40 wt % to 50 wt % ethanol or n-propanol. The ionomer solution may contain an ionomer content of 5 wt % to 30 wt % and be prepared from its individual ingredients or it may be acquired from a commercial source. One specific commercially-available ionomer solution that is useful in preparing the composite electrode layer 10 is designated D2020 and can be obtained from The Chemours Company. The D2020 ionomer solution includes 20-22 wt % 1000 EW Nafion® dissolved in a solvent that includes 42 wt % to 50 wt % n-propanol and 30 wt % to 38 wt % water.

The ionomer nanofibers 22 may be separately produced and then introduced into the ionomer solution in the desired amount. The ionomer nanofibers 22 may be produced with the desired length and diameter characteristics by any nanofiber-forming technique such as melt extrusion, electrospinning, melt blowing, forcespinning, drawing, or template synthesis, to name but a few options. Because the ionomer nanofibers 22 are insoluble in water as well as the solvent, they remain physically mixed with and suspended in the ionomer solution. In addition to the ionomer nanofibers 22, the catalyst 20 is also introduced into the ionomer solution in the desired amount, preferably after the ionomer nanofibers 22 have been added. The introduction of the ionomer nanofibers 22 and the catalyst 20 into the ionomer solution forms an electrode ink slurry. The electrode ink slurry, once formulated, is converted into the composite electrode layer 10 that overlies the proton-conductive solid polymer electrolyte 40 and is part of the MEA 30. There are numerous ways in which the electrode ink slurry may be converted into the composite electrode layer 10 that overlies the proton-conductive solid polymer electrolyte membrane 40. Several preferred options are described below.

To convert the electrode ink slurry into the composite electrode layer 10, the electrode ink slurry is first coated onto a substrate as a thin, wet precursor composite layer. The solvent contained within the wet precursor composite layer is then removed to derive the composite electrode layer 10. The solvent may be removed, for example, by heating the precursor composite layer in a vacuum oven at a temperature between 50° C. and 100° C. for a period of two minutes to ten minutes. This process of coating the electrode ink slurry and removing the solvent may be performed once or it may be performed multiple times at the same location on the substrate to sequentially build the composite electrode layer 10 in layers. In one embodiment, the substrate onto which the electrode ink slurry is coated and heated to remove the solvent is the proton-conductive solid polymer electrolyte 40 itself. In this way, the composite electrode layer 10 is applied directly to the proton-conductive solid polymer electrolyte 40 during manufacture of the MEA 30. Alternately, the substrate onto which the electrode ink slurry is coated may be the first gas diffusion media layer 32, if the composite electrode layer 10 is formed as the anode catalyst layer 42, or the second gas diffusion layer 34, if the composite electrode layer 10, as shown, is formed as the cathode catalyst layer 44, with or without the microporous layer 62, 64. The coated substrate will then be hot pressed against the proton-conductive solid polymer electrolyte membrane 40 to form the MEA 30.

In another embodiment, the substrate onto which the electrode ink slurry is coated and heated to remove the solvent is a decal substrate. The decal substrate has approximately the same length and width dimensions as the composite electrode layer 10 being formed and may be formed of fiberglass reinforced PTFE or poly(ethene-co-tetrafluoroethene) (ETFE) that has been treated with a Teflon release agent. The composite electrode layer 10 is then transferred to the proton-conductive solid polymer electrolyte membrane 40. The transfer of the composite electrode layer 10 involves positioning the coated decal substrate with the applied electrode layer 10 against a major face 12, 14 of the proton-conductive solid polymer electrolyte membrane 40 with the composite electrode layer 10 facing the polymer electrolyte membrane 40. The coated decal substrate is then hot-pressed against the proton-conductive solid polymer electrolyte 40 to transfer the composite electrode layer 10 onto the proton-conductive solid polymer electrolyte 40. The coated decal substrate may be hot pressed at a temperature of 130° C. to 150° C. at a compression pressure of 230 kPaa to 270 kPaa for a duration of two minutes to ten minutes. Upon completion of the hot-pressing, the decal substrate is peeled away from the composite electrode layer 10, which remains adhered to and retained on the proton-conductive solid polymer electrolyte membrane 40.

FIGS. 4-6 demonstrate some of the performance enhancing effects that can be attributed to the presence of the ionomer nanofibers 22 in the composite electrode layer 10 during PEM fuel cell operating conditions. In FIG. 4, for example, a polarization curve is shown for three PEM test fuel cells. The polarization curves shown here display the voltage output (y-axis in V) for a PEM fuel cell as a function of current density loading (x-axis in A/cm²). For each test cell, a platinum catalyst loading of 0.1 mg/cm² was used along with a high stoichiometry flow rate of Hz/air to ensure the cell reactions were not limited by the availability of H₂ or O₂. Of the three PEM test cells displayed here in FIG. 4, two of them included a composite electrode layer as the cathode catalyst layer and one included a conventional electrode layer as the cathode catalyst layer. The test cells that included a composite electrode layer are identified by reference numerals 86 (test cell 1) and 88 (test cell 2) and the test cell that included a conventional electrode layer is identified by reference numeral 90 (test cell 3).

Each of the test cells that included a composite electrode layer as the cathode catalyst layer was prepared from a D2020 ionomer solution and included ionomer nanofibers constructed of Aquivion P87-S02-F (Solvay Solexis, Sigma Aldrich) that was hydrolyzed to the SO₂—OH form and having diameters of about 200 nm to about 1500 nm and lengths of about 1 μm to about 10 μm. The amount of ionomer nanofibers in the cathode catalyst layer of the test cells ranged from 4 to 20 wt %. The composite electrode layer included in test cell 1 (86) was prepared from an ionomer solution that had a 4:1 weight ratio of D2020 to ionomer nanofibers, and the composite electrode layer included in the test cell 2 (88) was prepared from an ionomer solution that had a 2:1 weight ratio of D2020 to ionomer nanofibers. The conventional electrode layer included in the test cell 3 (90) as the cathode catalyst layer was prepared from an ionomer solution that contained D2020 and no ionomer nanofibers. As can be seen from the polarization curves displayed in FIG. 4, test cell 1 (86) had a better cell voltage performance than the test cell 3 (90) across almost the entire range of current density loading tested and, in fact, the voltage performance enhancement became more pronounced as the current density loading was increased. As for the test cell 2 (88), it performed comparably to the test cell 3 (90) up to approximately a current density loading of 1.0 A/cm², and then began to suffer a voltage decline. The relative voltage decline observed in test cell 2 (88) at current densities above 1.0 A/cm² is believed to be attributable in this particular test cell example to the larger amount of ionomer nanofibers included in the composite electrode layer and their contribution to mass transport voltage loss.

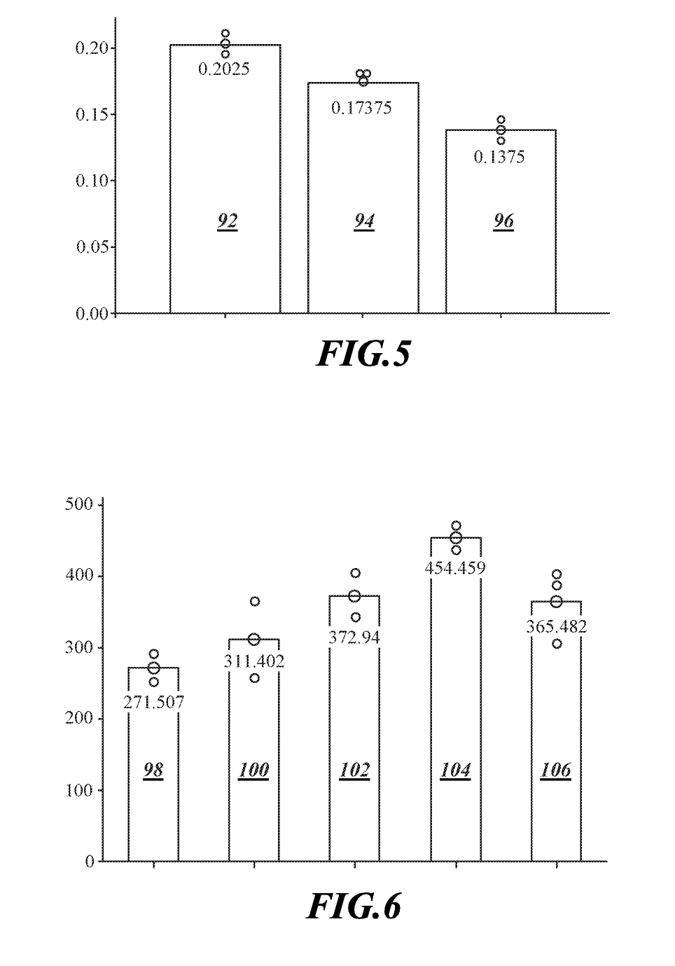

The polarization curves displayed in FIG. 4 demonstrate that the use of the composite electrode layer as the cathode catalyst layer can improve PEM fuel cell voltage performance, especially at high current densities. However, the results in FIG. 4 should not be interpreted to mean that a PEM fuel cell that includes the composite electrode layer that served as the cathode catalyst layer of test cell 2 (88) will always necessarily underperform a PEM fuel that includes a conventional cathode catalyst layer. A variety of factors can influence PEM fuel cell voltage performance and the effects of the ionomer nanofibers. For example, FIG. 5 is a graph of protonic resistance (R(H⁺)) (y-axis in Ωcm²) and FIG. 6 is a graph of mass activity (y-axis in mA/mg) for several different cathode catalyst layers that had varying amounts of the same ionomer nanofibers used in connection with FIG. 4. In FIG. 5, the cathode catalyst layers 92, 94, 96 were prepared from ionomer solutions that included no ionomer nanofibers, a 4:1 weight ratio of D2020 to ionomer nanofibers, and a 2:1 ratio of D2020 to ionomer nanofibers, respectfully. And in FIG. 6, the cathode catalyst layers 98, 100, 102, 104, 106 were prepared from ionomer solutions that included no D2020 and all ionomer nanofibers, a 1:3 weight ratio of D2020 to ionomer nanofibers, a 1:1 ratio of D2020 to ionomer nanofibers, a 3:1 ratio of D2020 to ionomer nanofibers, and all D2020 with no ionomer nanofiber, respectfully. These graphs show that the proton transport resistance of the cathode catalyst layer decreases with an increasing amount of the ionomer nanofibers, while the mass activity of the catalyst particles peaks with some addition of ionomer nanofibers and then begins to drop as more ionomer nanofibers are added.

The data provided in FIGS. 4-6 demonstrates that the composite electrode layer 10 described herein can be used in a PEM fuel cell to improve cell voltage performance. The characteristics of the ionomer nanofibers 22 (e.g., length, diameter, type of proton-conductive polymer) and their amount within the composite electrode layer 10 can be customized to meet the performance needs of the PEM fuel cell depending on a multitude of factors including the operating conditions of the cell and the particular construction of the other components of the cell. Specifically, to impart enhanced cell voltage performance at high current densities when the composite electrode layer is employed as the cathode catalyst layer of the PEM fuel cell MEA, it may be desirable to tailor the amount of ionomer nanofibers included in the electrode layer to not only decrease in the proton resistance of the electrode layer, but also increase in the mass activity of the catalyst particles. Such results can oftentimes be realized when the ionomer nanofibers are included in the composite electrode layer at an amount that ranges from 5 wt % to 20 wt % and, preferably, about 10 wt. % based on the total weight of the composite electrode layer, although upward and downward deviations may certainly be possible.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

What is claimed is:

1. A polymer electrolyte membrane fuel cell comprising:
a proton-conductive solid polymer electrolyte membrane, the polymer electrolyte membrane having a first face and an opposed second face;
an anode catalyst layer overlying the first face of the polymer electrolyte; and
a cathode catalyst layer overlying the second face of the polymer electrolyte;
wherein at least one of the anode catalyst layer or the cathode catalyst layer includes a composite electrode layer that comprises a colloidal or soluble ionomer binder component, a catalyst, and insoluble ionomer nanofibers disseminated throughout a thickness of the composite electrode layer such that at least some of the ionomer nanofibers contact the polymer electrolyte membrane, the ionomer nanofibers being present within the composite electrode layer at a weight percent ranging from 5 to 20 based on a total weight of the composite electrode layer.

2. The polymer electrolyte membrane fuel cell set forth in claim 1, wherein the ionomer nanofibers have an aspect ratio of greater than 20.

3. The polymer electrolyte membrane fuel cell set forth in claim 1, wherein at least some of the ionomer nanofibers are composed of a sulfonated fluoropolymer.

4. The polymer electrolyte membrane fuel cell set forth in claim 3, wherein at least some of the ionomer nanofibers are composed of a copolymer having a polytetrafluoroethylene backbone and perfluoroether pendant side chains that terminate in sulfonic acid groups.

5. The polymer electrolyte membrane fuel cell set forth in claim 1, wherein at least the cathode catalyst layer comprises the composite electrode layer.

6. The polymer electrolyte membrane fuel cell set forth in claim 1, wherein the colloidal or soluble ionomer binder component comprises a sulfonated fluoropolymer.

7. The polymer electrolyte membrane fuel cell set forth in claim 1, wherein the catalyst comprises platinum group metal nanoparticles supported on carbon support particles.

8. The polymer electrolyte membrane fuel cell set forth in claim 1, wherein at least some of the ionomer nanofibers extend from a first major face of the composite electrode layer to a second major face of the composite electrode layer and thereby fully traverse the thickness of the composite electrode layer.

9. The polymer electrolyte membrane fuel cell set forth in claim 1, further comprising:
a first gas diffusion media layer overlying the anode catalyst layer;
a second gas diffusion media layer overlying the cathode catalyst layer;
a first electrically-conductive flow field plate overlying the first gas diffusion media layer and configured to deliver hydrogen gas to the anode catalyst layer; and
a second electrically-conductive flow field plate overlying the second gas diffusion media layer and configured to deliver an oxidant gas to the cathode catalyst layer.

10. A polymer electrolyte membrane fuel cell comprising:
a proton-conductive solid polymer electrolyte membrane, the polymer electrolyte membrane having a first face and an opposed second face;
an anode catalyst layer overlying the first face of the polymer electrolyte;
a cathode catalyst layer overlying the second face of the polymer electrolyte, the cathode catalyst layer being a composite electrode layer that comprises a colloidal or soluble ionomer binder component, a catalyst dispersed along with the soluble ionomer binder component, and ionomer nanofibers disseminated throughout a thickness of the composite electrode layer so as to establish a random network of proton transport pathways across the thickness of the composite electrode layer from a first major face to a second major face of the composite electrode layer;
a first gas diffusion media layer overlying the anode catalyst layer;
a second gas diffusion media layer overlying the cathode catalyst layer;
a first electrically-conductive flow field plate overlying the first gas diffusion media layer and configured to deliver hydrogen gas to the anode catalyst layer; and
a second electrically-conductive flow field plate overlying the second gas diffusion media layer and configured to deliver an oxidant gas to the cathode catalyst layer.

11. The polymer electrolyte membrane fuel cell set forth in claim 10, wherein the ionomer nanofibers have an aspect ratio of greater than 20.

12. The polymer electrolyte membrane fuel cell set forth in claim 10, wherein the ionomer nanofibers are present within the composite electrode layer at a weight percent ranging from 5 wt % to 20 wt % based on a total weight of the composite electrode layer.

13. The polymer electrolyte membrane fuel cell set forth in claim 10, wherein the colloidal or soluble ionomer binder component comprises a sulfonated fluoropolymer, and wherein the catalyst comprises platinum group metal nanoparticles supported on carbon support particles.

14. The polymer electrolyte membrane fuel cell set forth in claim 10, wherein at least some of the ionomer nanofibers are composed of a sulfonated fluoropolymer.

15. A method of making a composite electrode layer for a polymer electrolyte membrane fuel cell, the method comprising:
preparing an ionomer solution that includes ionomer particles dissolved or dispersed in a solvent;
introducing insoluble ionomer nanofibers into the ionomer solution;
introducing a catalyst into the ionomer solution to form an electrode ink slurry;
casting the electrode ink slurry onto a surface of a substrate to apply a wet precursor composite layer to the substrate; and
removing the solvent from the wet precursor composite layer to derive a composite electrode layer on the surface of the substrate, the composite electrode layer having a first major face and an opposed second major face and including an interpenetrating porous matrix that includes the catalyst, a colloidal or soluble ionomer binder component distributed in and around the catalyst, the insoluble ionomer nanofibers disseminated throughout a thickness of the composite electrode layer such that at least some of the ionomer nanofibers are exposed at the first major face, the second major face, or both of the first and second major faces.

16. The method set forth in claim 15, wherein the substrate is a proton-conductive solid polymer electrolyte membrane or a gas diffusion media layer.

17. The method set forth in claim 15, wherein the substrate is a decal substrate.

18. The method set forth in claim 17, further comprising transferring the composite electrode layer from the decal substrate to a face of a proton-conductive solid polymer electrolyte membrane.

19. The method set forth in claim 15, wherein the colloidal or soluble ionomer binder component comprises a sulfonated fluoropolymer, and wherein the catalyst comprises platinum group metal nanoparticles supported on carbon support particles.

20. The method set forth in claim 15, wherein at least some of the ionomer nanofibers extend from the first major face of the composite electrode layer to the second major face of the composite electrode layer and thereby fully traverse the thickness of the composite electrode layer.
